(19) United States
(12) Patent Application Publication
(10) Pub. No.: US 2011/0070387 A1
(43) Pub. Date: Mar. 24, 2011

(54) POLYUREA COMPOSITION

(75) Inventors: Axel Schmidt, Singapore (SG); Malte Homann, Odenthal (DE); Andreas Aus Der Wieschen, Leverkusen (DE)

(73) Assignee: Bayer MaterialScience AG, Leverkusen (DE)

(21) Appl. No.: 12/993,533

(22) PCT Filed: May 7, 2009
(86) PCT No.: PCT/EP2009/003248

§ 371 Date: Nov. 19, 2010

(30) Foreign Application Priority Data
May 20, 2008 (DE) 10 2008 024 352.3

(51) Int. Cl. C08L 75/04; B32B 1/08

(52) U.S. Cl. 428/36.91; 524/500; 428/36.9

(57) ABSTRACT

A two-component coating system, containing (A) a polyisocyanate prepolymer having polyether groups bonded through allophanate groups, and (B) a mixture of polyamines in which (B1) at least 75 mol % of all NH groups originate from an amino-functional polyaspartic acid ester of the general formula (I):

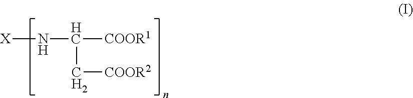

wherein, X represents an n-valent organic radical which is obtained by removing the primary amino groups from an n-valent polyamine; R¹ and R² independently of one another, represent organic radicals that are inert towards isocyanate groups under the reaction conditions; and n represents an integer of at least 2; and (B2) not more than 25 mol % of all NH groups originate from a cycloaliphatic diamine or aromatic diamine, and also (C) optionally a further polyisocyanate.

The present invention relates to materials having an increased bending modulus made from polyurea compositions.

Two-component coating systems based on polyurethanes or polyureas are known and are used industrially. They generally contain a liquid polyisocyanate component and a liquid isocyanate-reactive component. Polyurea coatings are formed by reaction of polyisocyanates with amines as isocyanate-reactive component. However, amines and isocyanates react very rapidly with one another in most cases. Typical pot lives or gel times are often only a few seconds. For this reason, such polyurea coatings cannot be applied manually but only by means of special spraying apparatus.

Coatings of polyureas are valuable especially because the reaction of polyisocyanates with amines proceeds extraordinarily rapidly and the coated surfaces are usable (again) very quickly. In addition, the presence of urea groups in polyurethanes leads to a very advantageous ratio of hardness to elasticity, which is very desirable in many coating applications, such as, for example, the coating of pipes. There are frequently used as amines specific aromatic diamines, the reaction of which with isocyanates to form corresponding polyurea systems proceeds comparatively slowly, which improves the processability and the properties of the material.

U.S. Pat. No. 3,428,610 and U.S. Pat. No. 4,463,126 disclose the preparation of polyurethane/polyurea elastomers by curing of NCO-functional prepolymers with aromatic diamines. These are preferably di-primary aromatic diamines, which contain at least one alkyl substituent having from 2 to 3 carbon atoms in the ortho-position relative to each amino group and, in addition, optionally methyl substituents in further ortho-positions relative to the amino groups, such as, for example, diethyltoluoyldiamine (DET-DA), an isomeric mixture of the isomeric forms 2,6-diamino-3,5-diethyltoluene and 2,4-diamino-3,5-diethyltoluene.

U.S. Pat. No. 4,463,126 describes a process for the preparation of solvent-free resilient coatings, in which NCO prepolymers based on isophorone diisocyanate (IPDI) and polyether polyols are cured at room temperature with sterically hindered di-primary aromatic diamines.

In order to render such polyurea coatings flexible, it is possible to add to the aromatic diamines according to EP-A 1 486 522, for example, polyhydroxy compounds, such as polyether or polyester polyols, prepolymers of hexamethylene diisocyanate (HDI), as well as the dimers and trimers thereof, or also amine-terminated polyethers. These possibilities for rendering polyurea coatings flexible have the following disadvantages, however: when polyethers and polyesters are used, the curing time increases considerably because the NCO/OH reaction is markedly slower than the NCO/NH₂ reaction. In addition, polyesters have a high viscosity, which makes them considerably more difficult to process in these highly reactive mixtures. Simple prepolymers of HDI or its oligomers also exhibit too high a viscosity and, in addition, incompatibilities in the fully reacted polyurea (inhomogeneous coatings). Because the reactivity of amine-terminated polyethers and aromatic diamines is very different, inhomogeneous systems are also produced thereby.

A further disadvantage of such systems is that the aromatic diamines have a pronounced tendency to yellowing.

Polyureas can also be used for coatings in contact with drinking water, as is described, for example, in EP-A 0 936 235. Such coatings are obtained by mixing a liquid aliphatic polyisocyanate, which can additionally also contain a liquid epoxy resin, with a liquid aromatic polyamine.

In the case of coatings that are in direct contact with drinking water, the use of aromatic raw materials is often regarded as disadvantageous. For example, aromatic amines could be released from aromatic isocyanates under certain conditions. For the same reason, the use of aromatic amines as chain extenders is often regarded as critical, because aromatic amines are categorised as undesirable by the responsible approval authorities, which can be recognised in very low migration thresholds. Aliphatic amines, on the other hand, in some cases have permissible migration thresholds that are higher by a factor of from 10 to 1000. In that respect, purely aliphatic binders are advantageous for such applications.

However, primary aliphatic amines have markedly higher reactivity towards isocyanates than do aromatic amines. The reactivity can be reduced, however, by converting a primary amine into a secondary amine. In particular, reaction with maleic acid diesters within the scope of a Michael addition or reaction with sterically hindered carbonyl compounds within the scope of a reductive amination yields aliphatic diamine chain extenders having a reactivity which offers a good compromise between processing time and curing time. The use of such so-called aspartic acid esters as chain extenders in polyurea coatings is known in principle.

WO2004/033517, EP-A 0 403 921 and U.S. Pat. No. 5,126,170 disclose the formation of polyurea coatings by reaction of polyaspartic acid esters with polyisocyanates. Polyaspartic acid esters have a low viscosity and reduced reactivity towards polyisocyanates and can therefore be used for the preparation of solvent-free coating compositions having extended pot lives.

However, despite their high tensile strength and ultimate elongation, such compositions have only limited suitability in many cases where mechanical stress is present as a result of bending stress. The resistance of a polymer to such bending stress can be described by its bending modulus.

Accordingly, the object underlying the present invention was to develop a polyurea coating
a) which is comparable in terms of its reactivity with coatings based on aromatic amines,
b) the preparation of which uses substantially aliphatic chain extenders, and
c) which has a high bending modulus.

That object has been achieved by the use of a combination of polyaspartic acid esters with specific aminic chain extenders which demonstrably increase the bending modulus without adversely affecting the other mechanical properties.

The present invention therefore provides two-component coating systems at least comprising
A) a polyisocyanate prepolymer having polyether groups bonded via allophanate groups, and
B) a mixture of polyamines in which
B1) at least 75 mol % of all NH groups originate from an amino-functional polyaspartic acid ester of the general formula (I)

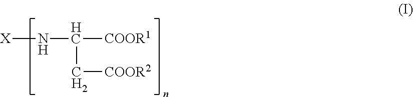

in which
X represents an n-valent organic radical which is obtained by removing the primary amino groups from an n-valent polyamine,
R¹ and R² represent identical or different organic radicals that are inert towards isocyanate groups under the reaction conditions, and
n represents an integer of at least 2,
and
B2) not more than 25 mol % of all NH groups originate from a cycloaliphatic diamine or aromatic diamine, and also
C) optionally further polyisocyanates.

The allophanates used in component A) are obtainable as follows:
A1) one or more aliphatic and/or cycloaliphatic polyisocyanates is/are reacted with
A2) one or more polyhydroxy compounds, wherein at least one is a polyether polyol,
   to give a NCO-functional polyurethane prepolymer, and the urethane groups thereof so formed are then partially or completely allophanatised with the addition of
A3) polyisocyanates, which can be different from those from A1), and
A4) catalysts,
A5) optionally stabilisers.

Examples of suitable aliphatic and cycloaliphatic polyisocyanates A1) are di- or tri-isocyanates, such as butane diisocyanate, pentane diisocyanate, hexane diisocyanate (hexamethylene diisocyanate, HDI), 4-isocyanatomethyl-1,8-octane diisocyanate (triisocyanatononane, TIN) or cyclic systems, such as 4,4′-methylene-bis(cyclohexylisocyanate), 3,5,5-trimethyl-1-isocyanato-3-isocyanatomethylcyclohexane (isophorone diisocyanate, IPDI) and also ω,ω′-diisocyanato-1,3-dimethylcyclohexane (H₆XDI).

There are preferably used as polyisocyanates in components A1) and A3) hexane diisocyanate (hexamethylene diisocyanate, HDI), 4,4′-methylene-bis(cyclohexylisocyanate) and/or 3,5,5-trimethyl-1-isocyanato-3-isocyanatomethylcyclohexane (isophorone diisocyanate, IPDI). A most particularly preferred polyisocyanate is HDI.

Polyisocyanates of the same type are preferably used in A1) and A3).

There can be used as polyhydroxy compounds of component A2) all polyhydroxy compounds known to the person skilled in the art, which preferably have a mean OH functionality of greater than or equal to 1.5, wherein at least one of the compounds present in A2) must be a polyether polyol.

Suitable polyhydroxy compounds which can be used in A2) are low molecular weight diols (e.g. 1,2-ethanediol, 1,3- and 1,2-propanediol, 1,4-butanediol), triols (e.g. glycerol, trimethylolpropane) and tetraols (e.g. pentaerythritol), polyether polyols, polyester polyols, polycarbonate polyols and also polythioether polyols. There are preferably used in A2) as polyhydroxy compounds only polyether-based substances of the above-mentioned type.

The polyether polyols used in A2) preferably have number-average molecular weights Mₙ of from 300 to 20,000 g/mol, particularly preferably from 1000 to 12,000 g/mol, most particularly preferably from 2000 to 6000 g/mol.

They also preferably have a mean OH functionality of 1.9, particularly preferably 1.95.

Such polyether polyols are obtainable in a manner known per se by alkoxylation of suitable starter molecules with base catalysis or using double metal cyanide compounds (DMC compounds).

Particularly suitable polyether polyols of component A2) are those of the above-mentioned type having a content of unsaturated end groups of less than or equal to 0.02 milliequivalents per gram of polyol (meq/g), preferably less than or equal to 0.015 meq/g, particularly preferably less than or equal to 0.01 meq/g (determination method ASTM D2849-69).

Such polyether polyols can be prepared in a manner known per se by alkoxylation of suitable starter molecules, in particular using double metal cyanide catalysts (DMC catalysis). This is described, for example, in U.S. Pat. No. 5,158,922 (e.g. Example 30) and EP-A 0 654 302 (p. 5, l. 26 to p. 6, l. 32).

Suitable starter molecules for the preparation of polyether polyols are, for example, simple, low molecular weight polyols, water, organic polyamines having at least two N—H bonds, or any desired mixtures of such starter molecules. Alkylene oxides suitable for the alkoxylation are in particular ethylene oxide and/or propylene oxide, which can be used in the alkoxylation in any desired sequence or alternatively in the form of a mixture.

Preferred starter molecules for the preparation of polyether polyols by alkoxylation, in particular by the DMC process, are in particular simple polyols, such as ethylene glycol, 1,3-propylene glycol and 1,4-butanediol, 1,6-hexanediol, neopentyl glycol, 2-ethyl-1,3-hexanediol, glycerol, trimethylolpropane, pentaerythritol, and also low molecular weight hydroxyl-group-containing esters of such polyols with dicarboxylic acids of the type mentioned below by way of example, or low molecular weight ethoxylation or propoxylation products of such simple polyols, or any desired mixtures of such modified or unmodified alcohols.

The preparation of the isocyanate-group-containing polyurethane prepolymers as intermediate is carried out by reacting the polyhydroxy compounds of component A2) with excess amounts of the polyisocyanates from A1). The reaction is generally carried out at temperatures of from 20 to 140° C., preferably from 40 to 100° C., optionally with the use of catalysts known per se from polyurethane chemistry, such as, for example, tin soaps, e.g. dibutyltin dilaurate, or tertiary amines, e.g. triethylamine or diazabicyclooctane.

The allophanatisation is then carried out by reaction of the isocyanate-group-containing polyurethane prepolymers with polyisocyanates A3), which can be the same as or different from those of component A1), suitable catalysts A4) for allophanatisation being added. Typically, the acidic additives of component A5) are then added for stabilisation purposes and excess polyisocyanate is removed from the product, for example by thin-layer distillation or extraction.

The molar ratio of the OH groups of the compounds of component A2) to the NCO groups of the polyisocyanates from A1) and A3) is preferably from 1:1.5 to 1:20, particularly preferably from 1:2 to 1:15, most particularly preferably from 1:2 to 1:10.

There are preferably used as catalysts in A4) zinc(II) compounds, these particularly preferably being zinc soaps of longer-chained, branched or unbranched, aliphatic carboxylic acids. Preferred zinc(II) soaps are those based on 2-ethylhexanoic acid as well as the linear, aliphatic C₄- to C₃₀-carboxylic acids. Most particularly preferred compounds of component A4) are Zn(II)-bis(2-ethylhexanoate), Zn(II)-bis(n-octoate), Zn(II)-bis(stearate) or mixtures thereof.

These allophanatisation catalysts are typically used in amounts of from 5 ppm to 5 wt. %, based on the total reaction mixture. Preferably from 5 to 500 ppm of the catalyst, particularly preferably from 20 to 200 ppm, are used.

It is also possible to use additives that have a stabilising action before, during or after the allophanatisation. These can be acidic additives, such as Lewis acids (electron-deficient compounds) or Broenstedt acids (protonic acids), or compounds that liberate such acids on reaction with water.

These are, for example, inorganic or organic acids or also neutral compounds, such as acid halides or esters, which react with water to give the corresponding acids. Particular mention may be made here of hydrochloric acid, phosphoric acid, phosphoric acid esters, benzoyl chloride, isophthalic acid dichloride, p-toluenesulfonic acid, formic acid, acetic acid, dichloroacetic acid and 2-chloropropionic acid.

The above-mentioned acidic additives can also be used to deactivate the allophanatisation catalyst. They additionally improve the stability of the allophanates prepared according to the invention, for example in the case of thermal stress during thin-layer distillation or after the preparation when the products are being stored.

The acidic additives are generally added at least in an amount such that the molar ratio of the acidic centres of the acidic additive and of the catalyst is at least 1:1. It is preferred, however, to add an excess of the acidic additive.

If acidic additives are used, they are preferably organic acids, such as carboxylic acids, or acid halides, such as benzoyl chloride or isophthalyl dichloride.

If excess diisocyanate is to be separated off, thin-layer distillation is the preferred method and is generally carried out at temperatures of from 100 to 160° C. and at a pressure of from 0.01 to 3 mbar. The residual monomer content thereafter is preferably less than 1 wt. %, particularly preferably less than 0.5 wt. % (diisocyanate).

All the process steps can optionally be carried out in the presence of inert solvents. Inert solvents are here to be understood as being those that do not react with the starting materials under the given reaction conditions. Examples are ethyl acetate, butyl acetate, methoxypropyl acetate, methyl ethyl ketone, methyl isobutyl ketone, toluene, xylene, aromatic or (cyclo)aliphatic hydrocarbon mixtures, or any desired mixtures of such solvents. The reactions according to the invention are, however, preferably carried out without a solvent.

The addition of the components that are involved can take place in any desired sequence either during the preparation of the isocyanate-group-containing prepolymers or during the allophanatisation. However, it is preferred to add the polyether polyol A2) to the polyisocyanates of components A1) and A3) in a reaction vessel and finally to add the allophanatisation catalyst A4).

In a preferred embodiment of the invention, the polyisocyanates of components A1) and A3) are placed in a suitable reaction vessel and heated to from 40 to 100° C., optionally with stirring. When the desired temperature has been reached, the polyhydroxy compounds of component A2) are then added, with stirring, and stirring is carried out until the NCO content reaches or is slightly below the theoretical NCO content of the polyurethane prepolymer that is to be expected according to the chosen stoichiometry. The allophanatisation catalyst A4) is then added and the reaction mixture is heated at from 50 to 100° C. until the NCO content reaches or is slightly below the desired NCO content. After addition of acidic additives as stabilisers, the reaction mixture is cooled or fed directly to thin-layer distillation. The excess polyisocyanate is thereby separated off at temperatures of from 100 to 160° C. and a pressure of from 0.01 to 3 mbar, to a residual monomer content of less than 1%, preferably less than 0.5%. After the thin-layer distillation, further stabiliser can optionally be added.

Such allophanates used in the claimed two-component coating systems typically correspond to the general formula (II)

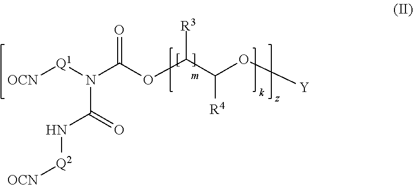

wherein
Q¹ and Q² independently of one another are the radical of a linear and/or cyclic aliphatic diisocyanate of the mentioned type, preferably —(CH₂)₆—,
R³ and R⁴ independently of one another are hydrogen or a C₁-C₄-alkyl radical, wherein R³ and R⁴ are preferably hydrogen and/or methyl groups and the meaning of R³ and R⁴ can be different in each repeating unit k,
Y is the radical of a starter molecule of the mentioned type having a functionality of from 2 to 6, and accordingly
z is a number from 2 to 6, which does not have to be an integer, of course, as a result of the use of different starter molecules, and
k preferably corresponds to sufficient monomer units that the number-average molecular weight of the polyether on which the structure is based is from 300 to 20,000 g/mol, and
m is 1 or 3.

There are preferably obtained allophanates which correspond to the general formula (III)

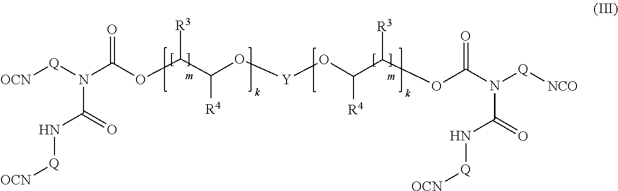

wherein
Q represents the radical of a linear and/or cyclic aliphatic diisocyanate of the mentioned type, preferably —(CH₂)₆—,
R³ and R⁴ independently of one another represent hydrogen or a C₁-C₄-alkyl radical, wherein R³ and R⁴ are preferably hydrogen and/or methyl groups, wherein the meaning of R³ and R⁴ can be different in each repeating unit m,
Y represents the radical of a difunctional starter molecule of the mentioned type, and
k corresponds to sufficient monomer units that the number-average molecular weight of the polyether on which the structure is based is from 300 to 20,000 g/mol, and
m is 1 or 3.

Because polyols based on polymerised ethylene oxide, propylene oxide or tetrahydrofuran are generally used for the preparation of the allophanates of formulae (II) and (III), it is particularly preferred for at least one of the radicals R³ and R⁴ to be hydrogen when m in formulae (II) and (III) is 1 and for R³ and R⁴ to be hydrogen when m is 3.

The allophanates used according to the invention in A) typically have number-average molecular weights of from 700 to 50,000 g/mol, preferably from 1500 to 8000 g/mol and particularly preferably from 1500 to 4000 g/mol.

The allophanates used according to the invention in A) typically have viscosities at 23° C. of from 500 to 100,000 mPas, preferably from 500 to 50,000 mPas and particularly preferably from 1000 to 7500 mPas, most particularly preferably from 1000 to 3500 mPas.

The group X in formula (I) of the polyaspartic acid esters of component B1) is preferably based on an n-valent polyamine selected from the group consisting of ethylenediamine, 1,2-diaminopropane, 1,4-diaminobutane, 1,6-diaminohexane, 2-methyl-1,5-diaminopentane, 2,5-diamino-2,5-dimethylhexane, 2,2,4- and/or 2,4,4-trimethyl-1,6-diaminohexane, 1,11-diaminoundecane, 1,12-diaminododecane, and polyether polyamines having aliphatically bonded primary amino groups having a number-average molecular weight Mn of from 148 to 6000 g/mol.

The group X is based particularly preferably on 1,4-diaminobutane, 1,6-diaminohexane, 2-methyl-1,5-diaminopentane, 2,2,4- and/or 2,4,4-trimethyl-1,6-diaminohexane and most particularly preferably on 2-methyl-1,5-diaminopentane.

In relation to the radicals R¹ and R², “inert towards isocyanate groups under the reaction conditions” means that those radicals do not contain any groups having Zerewitinoff-active hydrogen (CH-acidic compounds; see Römpp Chemie Lexikon, Georg Thieme Verlag Stuttgart) such as OH, NH or SH.

R¹ and R², independently of one another, are preferably C₁- to C₁₀-alkyl radicals, particularly preferably methyl or ethyl radicals.

n in formula (I) is preferably an integer from 2 to 6, particularly preferably from 2 to 4.

The preparation of the amino-functional polyaspartic acid esters B) is carried out in a manner known per se by reaction of the corresponding primary polyamines of the formula

X—[NH₂],

with maleic or fumaric acid esters of the general formula

R¹—OOC—CH═CH—COOR².

Suitable polyamines are the diamines mentioned above as the basis for the group X.

Examples of suitable maleic or fumaric acid esters are maleic acid dimethyl ester, maleic acid diethyl ester, maleic acid dibutyl ester and the corresponding fumaric acid esters.

The preparation of the amino-functional polyaspartic acid esters B) from the mentioned starting materials is carried out preferably within the temperature range from 0 to 100° C., the starting materials being used in relative proportions such that there is at least one, preferably precisely one, olefinic double bond for each primary amino group, it being possible for any starting materials used in excess to be separated off by distillation following the reaction. The reaction can be carried out without a solvent or in the presence of suitable solvents, such as methanol, ethanol, propanol or dioxane or mixtures of such solvents.

The cycloaliphatic or aromatic amine chain extenders from B2) are selected from the group 1,2-diaminocyclohexane, 1,4-diaminocyclohexane, 1,4-di(aminomethyl)cyclohexane, 1-amino-3,3,5-trimethyl-5-aminomethyl-cyclohexane, 2,4- and/or 2,6-hexahydro-toluylenediamine, 2,4′- and/or 4,4′-diamino-dicyclohexylmethane, 3,3′-dimethyl-4,4′-di-amino-dicyclohexylmethane, 3,3′,5,5′-tetramethyl-4,4′-diamino-dicyclohexylmethane, 2,4,4′-triamino-5-methyl-dicyclohexylmethane, 1,3-bis(aminomethyl)benzene and their (partial) reaction products with Michael acceptors selected from the group maleic acid diethyl ester, maleic acid dimethyl ester, acrylonitrile and mixtures thereof, or their (partial) reaction products with dialkyl ketones or aldehydes selected from the group acetone, methyl ethyl ketone, diethyl ketone, methyl isopropyl ketone, methyl isobutyl ketone, methyl tert-butyl ketone, cyclohexanone, tert-butylaldehyde, isopropylaldehyde, within the scope of a reductive amination. It is also possible to use as amine chain extenders in B2) substituted toluoylenediamines or methylene-bis(anilines). There may be mentioned specifically diethyltoluoylenediamine, dimethylthiotoluoylenediamine, in particular the isomers thereof having amino groups in the 2,4- and 2,6-position, as well as mixtures thereof, 4,4′-methylene-bis(2-isopropyl-6-methylaniline), 4,4′-methylene-bis(2,6-diisopropylaniline), 4,4′-methylene-bis(2-ethyl-6-methylaniline), as well as 4,4′-methylene-bis(3-chloro-2,6-di-ethylaniline), 4,4′-methylene-bis(2-chloroaniline). It is preferred, however, to use the (partial) reaction products of 1-amino-3,3,5-trimethyl-5-aminomethyl-cyclohexane, 2,4- and/or 2,6-hexahydrotoluoylenediamine or 2,4′- and/or 4,4′-diamino-dicyclohexylmethane with acrylonitrile or maleic acid diethyl ester, or the (partial) reaction products of 1-amino-3,3,5-trimethyl-5-aminomethyl-cyclohexane, 2,4- and/or 2,6-hexahydrotoluoylenediamine or 2,4′- and/or 4,4′-diamino-dicyclohexylmethane with acetone, methyl isobutyl ketone, methyl tert-butyl ketone or cyclohexanone, within the scope of a reductive amination, or to use diethyltoluoylenediamine, dimethylthiotoluoylenediamine, in particular the isomers thereof having amino groups in the 2,4- and 2,6-position, as well as 4,4′-methylene-bis(2,6-diisopropylaniline), 4,4′-methylene-bis(3-chloro-2,6-diethylaniline).

Most particular preference is given to the use of the reaction product of 1-amino-3,3,5-trimethyl-5-aminomethyl-cyclohexane with acrylonitrile, maleic acid diethyl ester or acetone, and also the reaction product of 2,4′- and/or 4,4′-diamino-dicyclohexylmethane with maleic acid diethyl ester or methyl isobutyl ketone, or the use of diethyltoluoylenediamine, 4,4′-methylene-bis(2,6-diisopropylaniline) as well as 4,4′-methyl-lene-bis(3-chloro-2,6-diethylaniline) as such.

As further polyisocyanates C) there can in principle be used all secondary products known per se of aliphatic or cycloaliphatic polyisocyanates having a uretdione, biuret and/or isocyanurate structure, which can be obtained by modification of monomeric diisocyanates known per se, such as butane diisocyanate, pentane diisocyanate, hexane diisocyanate (hexamethylene diisocyanate, HDI), 4-isocyanatomethyl-1,8-octane diisocyanate (triisocyanatononane, TIN) or cyclic systems such as 4,4′-methylene-bis(cyclohexyl isocyanate), 3,5,5-trimethyl-1-isocyanato-3-isocyanatomethylcyclohexane (isophorone diisocyanate, IPDI) as well as ω,ω′-diisocyanato-1,3-dimethylcyclohexane (H₆XDI).

The compositions according to the invention preferably contain polyisocyanates C) having a uretdione structure or isocyanurate structure, particularly preferably uretdiones or isocyanurates based on hexamethylene diisocyanate (HDI) and most particularly preferably isocyanurates based on hexamethylene diisocyanate (HDI).

Of course, conventional auxiliary substances and additives, such as pigments, (surface-coating) additives, thixotropic agents, flow aids, emulsifiers and stabilisers, can be added to the compositions according to the invention.

The addition of catalysts for curing is typically not necessary, but it is possible in principle.

The preparation of the compositions according to the invention is carried out by mixing components A), B) and optionally C) in any desired sequence before or during application, for example in the form of a coating. If a component C) is used, it is preferably first mixed with component A) and the resulting mixture is subsequently cured with component B).

The ratio of free or blocked amino groups to free NCO groups in the two-component coating systems according to the invention is from 0.5:1 to 2:1, preferably from 0.5:1 to 1.5:1, particularly preferably from 1:1 to 1.5:1.

For the preparation of the two-component coating systems according to the invention, the individual components are mixed with one another.

The mentioned coating compositions can be applied to surfaces by techniques known per se, such as spraying, immersion, flooding, roller coating, spread coating or pouring. After any solvents present have been allowed to evaporate, the coatings cure under ambient conditions or alternatively at higher temperatures of, for example, from 40 to 200° C.

The mentioned compositions can be applied, for example, to metals such as iron, steel, aluminium, bronze, brass, copper, plastics materials, ceramics materials such as glass, concrete, stone and natural materials, it being possible for the mentioned substrates to have previously been subjected to any pretreatment which may be necessary. The compositions are preferably applied to iron or steel, it being possible for the surfaces and/or the materials as a whole to be damaged by corrosion. Owing to their rapid curing and the material properties overall, the compositions according to the invention are particularly suitable also for the (internal) coating of structures which contain or convey liquids or gases, for example mineral oil, water, in particular drinking water, or chemicals. The compositions according to the invention can also be used for the coating of roofs, parking areas, ballast tanks in ships, loading areas in ships or motor vehicles, floors, swimming baths, gully holes, aquariums, tunnels. The mentioned compositions can also be used as a composite resin in combination with glass fibres or so-called geotextiles.

### EXAMPLES

Polyisocyanate 1: Desmodur® N3600, Bayer MaterialScience AG, Germany.
Polyisocyanate 2: Desmodur® XP2599, Bayer MaterialScience AG, Germany.
Amine 1: Desmophen® NH₁₂₂₀, Bayer MaterialScience AG, Germany.
Amine 2: see below
Amine 3: Ethacure® 100 (DETDA), Albemarle, USA,
Amine 4: Jefflink® 754, Huntsman, USA.
Amine 5: Desmophen® NH 1420, Bayer MaterialScience AG, Germany.
Amine 6: 4,4′-Methylene-bis(2-chloroaniline) (M-BOCA), Sigma-Aldrich, Germany.
Amine 7: Polyclear® 136, Hansson Group LLC, USA.

### Preparation of Amine 2:

4462 g of maleic acid diethyl ester are dissolved in 6650 g of methanol at 40° C. 2207 g of isophoronediamine are added dropwise in the course of 90 minutes. Stirring is carried out for 20 hours at 40° C. and the solvent is removed by distillation in vacuo. 6669 g of amine 2 are obtained.

| Examples | 1 | 2 | 3 | 4 | 5 |
|---|---|---|---|---|---|
| Polyisocyanate 1 | 50 | 50 | 50 | 50 | 50 |
| Polyisocyanate 2 | 50 | 50 | 50 | 50 | 50 |
| Amine 1 | 100 | 94 | 87 | 82 | 95 |
| Proportion of NH groups from amine 1 | 100% | 94% | 88% | 83% | 88% |
| Amine 2 | 0 | 6.4 | 12.8 | 18.4 | 0 |
| Proportion of NH groups from amine 2 | 0% | 6% | 12% | 17% | 0% |
| Amine 3 | 0 | 0 | 0 | 0 | 5 |
| Proportion of NH groups from amine 3 | 0% | 0% | 0% | 0% | 12% |
| NCO:NH | 1.1:1.0 | 1.1:1.0 | 1.1:1.0 | 1.1:1.0 | 1.1:1.0 |
| Gel time (seconds) | 130 | 120 | 140 | 160 | 120 |
| Tensile strength ISO EN 527 [MPa]: | 9.7 | 10.5 | 9.3 | 11.0 | 10.8 |
| Comparison with Example 1 | 100 | 108% | 96% | 113% | 111% |
| Ultimate elongation ISO EN 527 [%]: | 117 | 104 | 100 | 105 | 89 |
| Comparison with Example 1 | 100% | 89% | 86% | 90% | 76% |
| Notched impact strength ISO EN 179-1 | 59.4 | 61.3 | 57.1 | 61.4 | 45.0 |
| [kJ/m²] | | | | | |
| Comparison with Example 1 | 100% | 103% | 96% | 103% | 76% |
| Bending modulus ASTM D790-03 [MPa] | 65.0 | 81.0 | 115.0 | 170.0 | 252.0 |
| Comparison with Example 1 | 100% | 125% | 177% | 262% | 388% |
| Examples | 1 | 6 | 7 | 8 | 9 |
| Polyisocyanate 1 | 50 | 50 | 50 | 50 | 50 |
| Polyisocyanate 2 | 50 | 50 | 50 | 50 | 50 |
| Amine 1 | 100 | 97 | 93 | 90 | 86 |
| Proportion of NH groups from amine 1 | 100% | 94% | 88% | 83% | 78% |
| Amine 4 | 0 | 3 | 7 | 10 | 14 |
| Proportion of NH groups from amine 4 | 0% | 6% | 12% | 17% | 22% |
| NCO:NH | 1.1:1.0 | 1.1:1.0 | 1.1:1.0 | 1.1:1.0 | 1.1:1.0 |
| Gel time (seconds) | 130 | 120 | 110 | 110 | 105 |
| Tensile strength ISO EN 527 [MPa]: | 9.7 | 9.6 | 10.2 | 10.3 | 11.0 |
| Comparison with Example 1 | 100% | 99% | 105% | 106% | 113% |
| Ultimate elongation ISO EN 527 [%]: | 117 | 111 | 108 | 105 | 120 |
| Comparison with Example 1 | 100% | 95% | 92% | 90% | 103% |
| Notched impact strength ISO EN 179-1 | 59.4 | 55.6 | 62.3 | 57.7 | 61.1 |
| [kJ/m²] | | | | | |
| Comparison with Example 1 | 100% | 94% | 105% | 97% | 103% |
| Bending modulus ASTM D790-03 [MPa] | 65 | 86 | 116 | 166 | 203 |
| Comparison with Example 1 | 100% | 132% | 178% | 255% | 312% |
| Examples | 1 | 10 | 11 | 12 | 13 |
| Polyisocyanate 1 | 50 | 50 | 50 | 50 | 50 |
| Polyisocyanate 2 | 50 | 50 | 50 | 50 | 50 |
| Amine 1 | 100 | 93 | 86 | 80 | 73 |
| Proportion of NH groups from amine 1 | 100% | 94% | 88% | 83% | 76% |
| Amine 5 | 0 | 7 | 14 | 20 | 27 |
| Proportion of NH groups from amine 5 | 0% | 6% | 12% | 17% | 24% |
| NCO:NH | 1.1:1.0 | 1.1:1.0 | 1.1:1.0 | 1.1:1.0 | 1.1:1.0 |
| Gel time (seconds) | 130 | 120 | 130 | 140 | 150 |
| Tensile strength ISO EN 527 [MPa]: | 9.7 | 10.0 | 10.1 | 10.6 | 11.0 |
| Comparison with Example 1 | 100% | 103% | 104% | 109% | 113% |
| Ultimate elongation ISO EN 527 [%]: | 117 | 117 | 119 | 111 | 108 |
| Comparison with Example 1 | 100% | 100% | 102% | 95% | 92% |
| Notched impact strength ISO EN 179-1 | 59.4 | 56.3 | 54.7 | 52.0 | 50.5 |
| [kJ/m²] | | | | | |
| Comparison with Example 1 | 100% | 95% | 92% | 88% | 85% |
| Bending modulus ASTM D790-03 [MPa] | 65 | 98 | 146 | 220 | 320 |
| Comparison with Example 1 | 100% | 151% | 225% | 339% | 492% |

| Examples | 1 | 14 | 15 | 16 | 17 | 18 |
|---|---|---|---|---|---|---|
| Polyisocyanate 1 | 50 | 50 | 50 | 50 | 50 | 50 |
| Polyisocyanate 2 | 50 | 50 | 50 | 50 | 50 | 50 |
| Amine 1 | 100 | 96 | 93 | 89 | 85 | 93 |
| Proportion of NH groups from | 100% | 94% | 88% | 82% | 76% | 88% |
| amine 1 | | | | | | |
| Amine 6 | 0 | 6 | 7 | 11 | 15 | 0 |
| Proportion of NH groups from | 0% | 6% | 12% | 18% | 24% | 0% |
| amine 6 | | | | | | |
| Amine 7 | 0 | 0 | 0 | 0 | 0 | 7 |
| Proportion of NH groups from | 0% | 0% | 0% | 0% | 0% | 12% |
| amine 7 | | | | | | |
| NCO:NH | 1.1:1.0 | 1.1:1.0 | 1.1:1.0 | 1.1:1.0 | 1.1:1.0 | 1.1:1.0 |
| Gel time (seconds) | 130 | 80 | 90 | 100 | 110 | 105 |
| Tensile strength ISO EN 527 | 9.7 | 11.5 | 11.4 | 11.2 | 11.6 | 11.5 |
| [MPa]: | | | | | | |
| Comparison with Example 1 | 100% | 119% | 118% | 115% | 120% | 119% |
| Ultimate elongation | 117 | 124 | 114 | 103 | 109 | 98 |
| ISO EN 527 [%]: | | | | | | |
| Comparison with Example 1 | 100% | 106% | 97% | 88% | 93.2% | 84% |
| Notched impact strength | 59.4 | 61.5 | 61.7 | 58.1 | 52.0 | 51.0 |
| ISO EN 179-1 [kJ/m²] | | | | | | |
| Comparison with Example 1 | 100% | 104% | 104% | 98% | 88% | 86% |
| Bending modulus | 65 | 85 | 107 | 164 | 265 | 267 |
| ASTM D790-03 [MPa] | | | | | | |
| Comparison with Example 1 | 100% | 131% | 165% | 252% | 408% | 411% |

Example 1 contains as chain extender only a non-cyclic diamine. By addition of different cyclic diamine chain extenders the bending modulus is increased by up to 492% of the initial value. The other material properties, such as tensile strength, ultimate elongation and notched impact strength, remain almost unchanged (deviations from the initial value<20%).

1-10. (canceled)

11. A two-component coating system, comprising:
A) a polyisocyanate prepolymer having polyether groups bonded through allophanate groups, and
B) a mixture of polyamines in which
B1) at least 75 mol % of all NH groups originate from an amino-functional polyaspartic acid ester of the general formula (I) 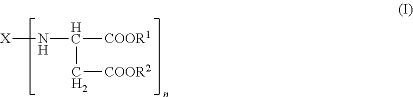
wherein,
X represents an n-valent organic radical which is obtained by removing the primary amino groups from an n-valent polyamine;
R¹ and R² independently of one another, represent organic radicals that are inert towards isocyanate groups under the reaction conditions; and
n represents an integer of at least 2; and
B2) not more than 25 mol % of all NH groups originate from a cycloaliphatic diamine or aromatic diamine, and also
C) optionally a further polyisocyanate.

12. The two-component coating system according to claim 11, wherein the allophanates used for synthesising the polyisocyanate prepolymer A correspond to the general formula (II) 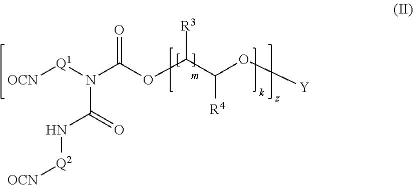
wherein,
Q¹ and Q² independently of one another represent a radical of a linear and/or cyclic aliphatic diisocyanate;
R³ and R⁴ independently of one another, represent hydrogen or a C₁-C₄-alkyl radical, wherein the meaning of R³ and R⁴ can be different in each repeating unit k;
Y represents a radical of a starter molecule having a functionality of from 2 to 6; and accordingly
z represents a number from 2 to 6, which does not have to be an integer as a result of the use of different starter molecules in Y; and
k corresponds to sufficient monomer units that the number-average molecular weight of the polyether on which the structure is based is from 300 to 20,000 g/mol; and
m is 1 or 3.

13. The two-component coating system according to claim 12, wherein Q¹ and/or Q² is —(CH₂)₆—.

14. The two-component coating system according to claim 12, wherein R³ and R⁴, independently of one another, represent hydrogen or methyl groups.

15. The two-component coating system according to claim 13, wherein R³ and R⁴, independently of one another, represent hydrogen or methyl groups.

16. The two-component coating system according to claim 11, wherein the allophanates correspond to the general formula (III): 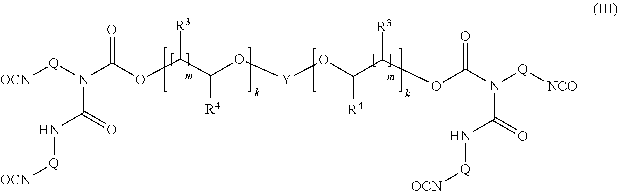
wherein
Q represents the radical of a linear and/or cyclic aliphatic diisocyanate,
R³ and R⁴ independently of one another, represents hydrogen or a C₁-C₄-alkyl radical, wherein the meaning of R³ and R⁴ can be different in each repeating unit m,
Y represents the radical of a difunctional starter molecule, and
k represents an integer that corresponds to a sufficient number of monomer units so that the number-average molecular weight of the polyether on which the structure is based is from 300 to 20,000 g/mol, and
m is 1 or 3.

17. The two-component coating system according to claim 16, wherein Q is —(CH₂)₆—.

18. The two-component coating system according to claim 16, wherein R³ and R⁴, independently of one another, represents hydrogen or methyl groups.

19. The two-component coating system according to claim 18, wherein R³ and R⁴, independently of one another, represents hydrogen or methyl groups.

20. A substrate which holds or conveys liquids or gases comprising the two-component coating system according to claim 11.

21. The substrate according to claim 20, wherein the substrate is a pipe.

22. The substrate according to claim 21, wherein the two-component coating system is disposed on the internal surface of the pipe.

23. The substrate according to claim 21, wherein the pipe transports drinking water.

24. The substrate according to claim 22, wherein the pipe transports drinking water.

25. The substrate according to claim 20, wherein the substrate is used to store water.

26. The substrate according to claim 20, wherein the substrate is a roof.

27. The substrate according to claim 20, wherein the substrate is a ballast tank of a ship.
